(19) United States
(12) Patent Application Publication
(10) Pub. No.: US 2002/0044044 A1
(43) Pub. Date: Apr. 18, 2002

(54) Remote control service system for restaurant or the like

(76) Inventor: Chin Ping Liao, Chong Ho City (TW)

Correspondence Address: Chin Ping Liao, P.O. Box 10-69, Chong Ho, Taipei, 235, TW

(21) Appl. No.: 09/908,922

(22) Filed: Jul. 20, 2001

(30) Foreign Application Priority Data
Oct. 12, 2000 (TW) 089217684

(51) Int. Cl. G08B 1/00

(52) U.S. Cl. 340/286.09; 340/286.06

(57) ABSTRACT

A remote control device includes a number of primary emitting devices each having an inbuilt coordinate for showing the location, and each having one or more buttons for entering the requests, and each having an emitting circuit for emitting out the request signal. A receiver device includes a receiving circuit for receiving the request signals, a processor unit for treating the signal, and a displayer for displaying the signal. A number of responding emitting devices may be used for responding and canceling the signal as shown in the displayer.

### BACKGROUND OF THE INVENTION

1. Field of the Invention

The present invention relates to a remote control system, and more particularly to a remote control system for restaurant or the like.

2. Description of the Prior Art

Typically, in a restaurant, different and various guests have different or various kinds of services required, such as orders, request for water or drink, request for adding dishes or entrees, request for ash trays or napkins or tablewares, etc. The guests may have to look around in order to find a waiter or waitress to ask for service, and may even required to speak louder in order to get the waiter or the waitress for services. In addition, the waiters and the waitress have to around and around to find if any guests are required for services. This may make large noises and may spoil the dining atmosphere.

Most of the times, the waiters and the waitress are required to go to the guests to see what kind of services required, and then are required to obtain the required objects or the like for fulfilling the guests' requirements. It may take times and may waist times for both the guests and the waiters and the waitress. In addition, a lot more waiters and waitress are required for such kind of diverse services.

The present invention has arisen to mitigate and/or obviate the afore-described disadvantages of the conventional restaurant control methods.

### SUMMARY OF THE INVENTION

The primary objective of the present invention is to provide a remote control system for facilitating the services for such as the restaurant or the like.

The other objective of the present invention is to provide a remote control system including a receiver device for receiving the request signals and for displaying the requests on a displayer.

The further objective of the present invention is to provide a remote control system including a number of primary emitting device for emitting the required requests or services, and a number of responding emitting devices for responding the requests.

In accordance with one aspect of the invention, there is provided a remote control system comprising a plurality of primary emitting devices each including an inbuilt location coordinate for showing a location of the primary emitting device, and each including at least one first button for entering a request signal, and each including an emitting circuit for emitting out the request signal, a receiver device including a receiving circuit for receiving the request signal from the primary emitting devices, a processor unit for receiving and treating the request signal, and a displayer for displaying the request signal, and a plurality of responding emitting devices each including at least one second button for responding to the request signal as shown in the displayer, and each including an emitting circuit for emitting out a signal to the receiver device in order to cancel the displayed request signal.

The primary emitting devices each includes an encoding circuit for encoding the request signal. The responding emitting devices each also preferably includes an encoding circuit for encoding purposes.

The receiver device includes a first amplifier coupled to the receiving circuit for amplifying the signal from the receiving circuit. The receiver device includes a comparator coupled to the first amplifier for comparing purposes. The receiver device includes a second amplifier coupled to the comparator.

The processor unit includes an encoding circuit for encoding the signal. The primary emitting devices each includes a light device for sending out a light signal when the at least one first button is depressed.

The receiver device includes a memory coupled to the processor unit for storing the signals. The primary emitting devices each includes a cancel button for canceling the request signal. The primary emitting devices each includes a light device for sending out a light signal when the cancel button is depressed.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram of a receiver device of a remote control system in accordance with the present invention;

FIGS. 2 and 3 are block diagrams showing two different emitting device of the remote control system; and

FIG. 4 is a block diagram illustrating the operation of the remote control system.

### DETAILED DESCRIPTION OF THE PREFERRED EMBODIMENT

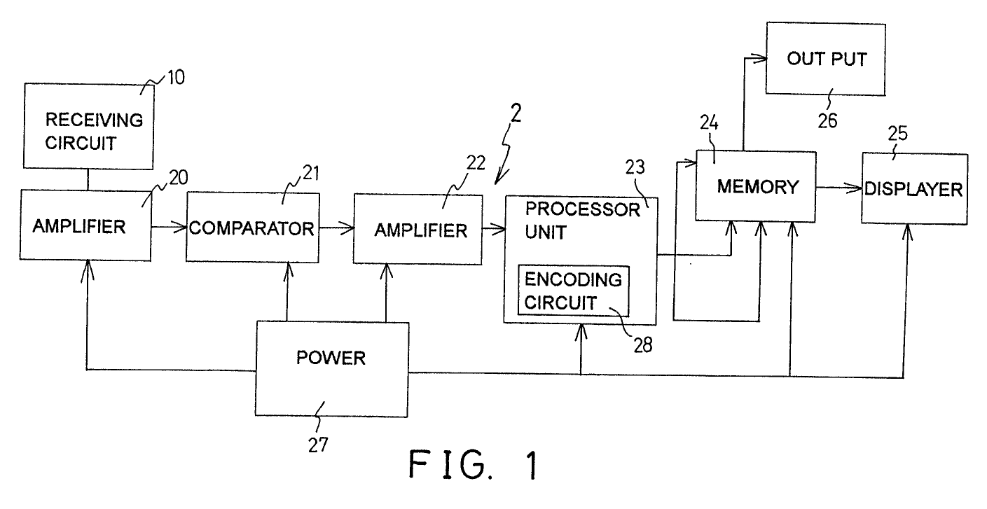

Referring to the drawings, and initially to FIG. 1, a remote control system in accordance with the present invention comprises a receiver device 2 including a receiving circuit 10 for receiving the request signals or the like, such as a radio frequency (RF) signals, a processor unit 23, and a first amplifier 20 and a comparator 21 and a second amplifier 22 coupled between the receiving circuit 10 and the processor unit 23 for amplifying the signals. The comparator 21 may oscillating and/or comparing the signals in order to obtain a useful Low frequency signal, such as the 320 MHz±5 MHz signals. The processor unit 23 includes an encoding circuit 28 for receiving and treating or encoding the signals and for sending out or for allowing the signals to be emitted outward, for example.

The receiver device 2 includes a memory 24 for storing the signals, and a displayer 25 for displaying the signals or requests, etc., and may include an output device 26, such as a blink light device, a buzzer, or the like, for generating an output signal, for example. A power device 27 may be used for energizing the elements or electric facilities.

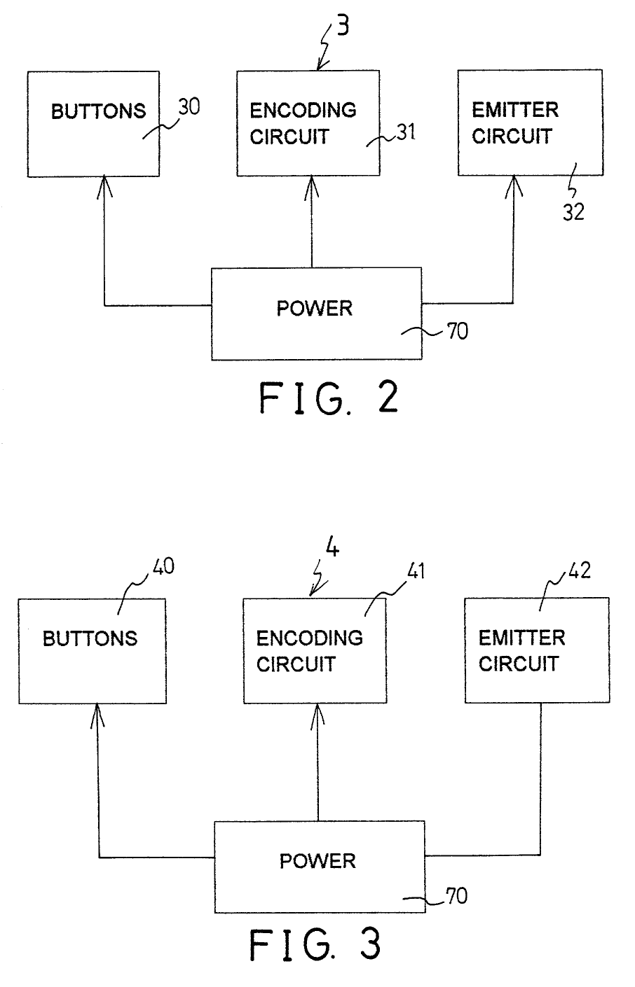

Referring next to FIGS. 2-4, the remote control system includes a number of primary emitting devices 3 (FIG. 2) disposed on each of the dining tables or the like, for example, for emitting the required requests or services, and a number of responding emitting devices 4 (FIG. 3) for responding the requests as requested by the guests or the like. The waiters and the waitress each preferably keep or carry one of the responding emitting devices 4 for responding to the requests as requested by the guests or the like.

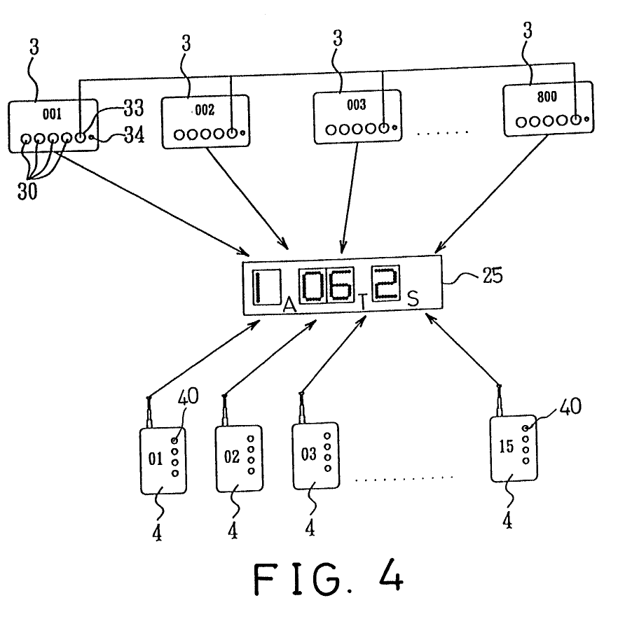

The primary emitting devices 3 are to be disposed on each of the dining tables which has a definition of the location of the dining table inbuilt therein. For example, the primary emitting devices 3, that is disposed on a first table, has an inbuilt location or coordinate defined by the table, such as the number of the area and the number of the table located. The primary emitting devices 3 (FIGS. 2, 4) each includes one or more buttons JO for entering the required services, and an encoding circuit 31 coupling the buttons 30 to an emitter circuit 32 for emitting out the required services. A power 70, such as one or more batteries may be used for energizing the parts or elements of the primary emitting devices 3.

The buttons 30 may be numbered for entering different requests. For example, the first button 30 may be used for ordering dishes or the like, the second button 30 may be used for request water or drink or the like, the third button 30 may be used for settling the accounts or the like, and the fourth button 30 may be used for the other services. Another button 33 (FIG. 4) may be used for canceling the requests or the like. The primary emitting devices 3 each further includes a light device 34, such as a light emitting diode, a liquid crystal displayer or the like, for signaling purposes. For example, the light device 34 may be energized when either of the buttons 30, 33 is depressed or actuated, in order to confirm that the buttons 30, 33 have been depressed or actuated, and in order to confirm that the request signals have been sent to the receiver device 2.

The processor unit 23 of the receiver device 2, after receiving the requested signals, may process or encode the signals and stored or memorized in the memory 24, and may then send out the signals and display the signals on the displayer 25. For example, as shown in FIG. 4, when the primary emitting device 3 disposed on the table that is located at area “1 ”, and at table number “6”, the “1A 06T” will be shown or displayed on the displayer 25. When the second button 30 is depressed, the “2s” may also be shown or displayed on the displayer 25. The waiters and the waitress now may easily know that the guest at area “1” and at table number “6” is required to add water or drink, and may quickly obtain and take the water or the drink toward the guest, without first asking the requirements of the guests.

As shown in FIGS. 3 and 4, the waiters and the waitress each may carry one of the responding emitting devices 4 with them. The responding emitting devices 4 each includes one or more buttons 40 for responding the required services, and an encoding circuit 41 coupling the buttons 40 to an emitter circuit 42 for emitting out the responding signals. A power 70, such as one or more batteries, may be used for energizing the parts or elements of the responding emitting devices 4. The waiters and the waitress may depress either of the buttons 40 to cancel the signals shown on the displayer 25 and to respond to the guests. The buttons 30, 40 may have an inbuilt light device for allowing the buttons 30, 40 to be seen in the dark environment.

In operation, many guests may depress the buttons 30 in a short time. The requests from the guests may be received by the receiver device 2 and may be stored in the memory 24. The requests may be shown one by one on the displayer 25, in such as a first in and first out system. Alternatively, the displayer 25 may include two or more screens to show two or more signals or requests simultaneously, and to show the sequence of the requests from the guests. When one of the waiters and the waitress has depressed one of the buttons 40, the first or the selected signal or request may first be changed from flash to continuous lighting status for about 3 or more seconds, and may then be canceled. When the request of a guest has been entered, but has not been shown in the displayer 25 yet, and when a waiter or a waitress has go to the guest and to respond to the guest, the button 33 may be depressed to cancel the previously entered requests.

Normally, the signals emitted by the emitting devices 3, 4 may be received by a receiver device 2 that is about 80 m away from the emitting devices 3, 4. When the distance is greater than 80 m, one or more repeating installations may be provided and disposed and spaced from each other for receiving and sending the signals to the receiver device 2. The receiver device 2 may receive the signals from more than 800 emitting devices 3, 4. The buttons 40 of the responding emitting devices 4 may be used for selecting or responding to the selected requests as listed in or on the displayer 25.

Accordingly, the remote control system in accordance with the present invention may be used for facilitating the services for such as the restaurant or the like, and includes a receiver device for receiving the request signals and for displaying the requests on a displayer, and includes a number of primary emitting device for emitting the required requests or services, and a number of responding emitting devices for responding the requests.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A remote control system comprising:
a plurality of primary emitting devices each including an inbuilt location coordinate for showing a location of said primary emitting device, and each including at least one first button for entering a request signal, and each including an emitting circuit for emitting out the request signal,
a receiver device including a receiving circuit for receiving the request signal from said primary emitting devices, a processor unit for receiving and treating the request signal, and a displayer for displaying the request signal, and
a plurality of responding emitting devices each including at least one second button for responding to the request signal as shown in said displayer, and each including an emitting circuit for emitting out a signal to said receiver device in order to cancel the displayed request signal.

2. The remote control system according to claim 1, wherein said primary emitting devices each includes an encoding circuit for encoding the request signal.

3. The remote control system according to claim 1, wherein said responding emitting devices each includes an encoding circuit for encoding purposes.

4. The remote control system according to claim 1, wherein said receiver device includes a first amplifier coupled to said receiving circuit for amplifying the signal from said receiving circuit.

5. The remote control system according to claim 4, wherein said receiver device includes a comparator coupled to said first amplifier for comparing purposes.

6. The remote control system according to claim 5, wherein said receiver device includes a second amplifier coupled to said comparator.

7. The remote control system according to claim 1, wherein said processor unit includes an encoding circuit for encoding the signal.

8. The remote control system according to claim 1, wherein said primary emitting devices each includes a light device for sending out a light signal when said at least one first button is depressed.

9. The remote control system according to claim 1, wherein said receiver device includes a memory coupled to said processor unit for storing the signals.

10. The remote control system according to claim 1, wherein said primary emitting devices each includes a cancel button for canceling the request signal.

11. The remote control system according to claim 10, wherein said primary emitting devices each includes a light device for sending out a light signal when said cancel button is depressed.
